(19) United States
(12) Patent Application Publication
(10) Pub. No.: US 2026/0346655 A1
(43) Pub. Date: Nov. 5, 2026

(54) COMMERCIAL-VEHICLE TIRE

(71) Applicant: Continental Reifen Deutschland GmbH, Hannover (DE)

(72) Inventors: Bharat Mohan Redrouthu, Hannover (DE); Frank Hengesbach, Datteln (DE); Jens Kleffmann, Hannover (DE); Volkmar Fries, Wedemark (DE); Anton Panacek, Lysa pod Makytou (SK)

(73) Assignee: Continental Reifen Deutschland GmbH, Hannover, OT (DE)

(21) Appl. No.: 19/099,648

(22) PCT Filed: Jun. 20, 2023
(86) PCT No.: PCT/DE2023/200119

§ 371 Date: Jan. 29, 2025

(30) Foreign Application Priority Data
Jul. 29, 2022 (DE) 10 2022 207 875.6

(51) Int. Cl. B60C 15/06

(52) U.S. Cl. CPC B60C 15/0607; B60C 2015/061; B60C 2200/06

(57) ABSTRACT

The invention relates to a commercial vehicle tire comprising bead regions each having
a bead core, a flange profile and an apex which is composed
in each case of a radially outer apex portion and a
radially inner apex portion which is in contact with the bead core, the
radially outer apex portion and the radially inner apex portion
differing from one another in terms of the rubber material thereof. The radially inner apex portion has a cross-sectional area having a surface area of 60% to 160% of the surface area of the cross-sectional area of the bead core, the rubber material of the radially inner apex portion having a stress at 100% elongation which is greater than the stress of the rubber material of the radially outer apex portion by 2.00 MPa to 30.00 MPa, and the rubber material of the radially outer apex portion having a rebound resilience at 70 °C which is greater than the rebound resilience of the rubber material of the radially inner apex portion by 5.0 to 50.0 percentage points.

The invention relates to a commercial vehicle tire comprising bead regions each having a bead core, a two-part apex sitting radially outward on the bead core, and a flange profile, and further comprising a single-layer or multi-layer carcass inlay wrapped around the bead cores, each apex being composed of a radially outer apex portion and a radially inner apex portion which is in contact with the bead core, the radially outer apex portion and the radially inner apex portion each consisting of a rubber material, and the rubber material of the radially outer apex portion being different from the rubber material of the radially inner apex portion.

A commercial vehicle tire of the type mentioned at the outset is known for example from DE 10 2014 211 525 A1. The commercial vehicle tire comprises a steel cord bead reinforcement extending on the outer side of the carcass inlay, a two-part apex in each bead region, and two reinforcing plies made of textile reinforcing material embedded in rubber extending on the outer side of the steel cord bead reinforcement. The apex comprises a radially outer apex portion and a radially inner apex portion, wherein in one embodiment, the rubber material of the radially outer apex portion differs from the rubber material of the radially inner apex portion in terms of the hardness thereof. The reinforcing plies end radially within the bead core and, in the radial direction, reach a height which relates to a line extending in the axial direction through the rim transition point and is at least 70 mm, the ends of the reinforcing plies located at this height being at a distance from one another of up to 10.0 mm in the radial direction. The reinforcing plies provide greater rigidity in the upper bead and side-wall regions, as a result of which the rolling resistance of the commercial vehicle tire is reduced by 2% to 5%.

Another commercial vehicle tire of the type mentioned at the outset, which is a tapered bead seat tire, is known from DE 10 2014 213 240 A1. The commercial vehicle tire comprises an inner layer which is optionally combined with a filler profile, a carcass inlay forming a carcass turn-up, in each bead region a steel cord bead reinforcement extending on the outer side of the carcass inlay and having a portion extending on the tire outer side and a portion extending on the tire inner side, and an apex made of a radially outer apex portion and a radially inner apex portion. The rubber material of the radially outer apex portion can be different from the rubber material of the radially inner apex portion. Between the inner layer or the filler profile and the portion of the steel cord bead reinforcement extending on the tire inner side and the portion of the carcass inlay which is adjacent thereto in the radial direction, a reinforcing ply extends out into textile reinforcing materials embedded in rubber, which provides a particularly high load capacity and a high mileage range.

JP 2000 108 616 A discloses a commercial vehicle tire comprising bead regions each having a multi-part apex made of at least two apex portions. According to one exemplary embodiment, the apex is composed of a radially inner apex portion and a radially outer apex portion, the rubber material of the radially inner apex portion having a greater hardness than the rubber material of the radially outer apex portion. This is intended to provide good bead durability.

It is also known that the design of the bead regions of a commercial vehicle tire has a decisive influence on the driving stability, the steering behavior, the suspension comfort and the seat of the tire on the rim. In this case, it is of particular importance to avoid variations in rigidity in the bead regions and to ensure the most uniform possible (smooth) progression of rigidity. The rigidity is highest in the region of the bead cores, the bead cores being responsible for a secure and tight fit of the tire on the rim. In the side-wall regions which have a thinner design, the rigidity is less than in the vicinity of the bead cores, as a result of which the tires can periodically compress during rolling (flexing). Too much compression leads to greater flexing and thus to thermal heating, as a result of which the tire can sustain damage. The rigidity and the progression of rigidity in the bead region and side-wall region is influenced by the apex. In this case, the compression should not take place too close to the rim flanges of the rim, since this increases the risk that the rim flanges of the tire will deform, and the bead regions of the tire will be damaged. If damage occurs in the bead regions, it is no longer possible to carry out retreading of the tire in the region of the tread.

Furthermore, it is currently conventional to use single-part apexes made of a single rubber material having an “average” or “low” rigidity. As a result of the triangular cross-sectional shape thereof, single-part apexes also provide a corresponding progression of rigidity in the bead region and side-wall region, the single-part apexes being vastly inferior to the multi-part apexes in this respect. Single-part apexes are thus not optimal in terms of bead durability, but when making a corresponding selection of the rubber material, they have proven to be advantageous in terms of the rolling resistance.

The multi-part apexes which have been known up to now, made of at least two apex parts in which it is conventional for one apex portion to consist of a rubber material having a greater rigidity and the other apex part to consist of a rubber material having a lower rigidity, are particularly advantageous for bead durability, so that the risk of tire damage in the bead region is reduced, and the commercial vehicle tire is therefore conventionally considered for retreading.

When designing and configuring apexes, there is thus only a hitherto insufficiently solved conflict of objectives between the rolling resistance and the bead durability which is directly related to retreadability.

The object of the invention is thus that of designing a commercial vehicle tire of the type mentioned at the outset in a much more advantageous manner than before with regard to the conflict of objectives between the rolling resistance and the bead durability.

The stated object is achieved according to the invention in that
the radially inner apex portion has a cross-sectional area having a surface area of 60% to 160% of the surface area of the cross-sectional area of the bead core,
the rubber material of the radially inner apex portion having a stress at 100% elongation—determined in accordance with DIN 53504 with the test piece type S3—which is 2.00 MPa to 30.00 MPa greater than the stress at 100% elongation of the rubber material of the radially outer apex portion and
the rubber material of the radially outer apex portion having a rebound resilience at 70 °C—determined in accordance with ISO 4662, with a test piece having a thickness of 6.3 mm±0.5 mm according to Annex A of ISO 4662—which is greater than the rebound resilience at 70 °C of the rubber material of the radially inner apex portion by 5.0 to 50.0 percentage points.

According to the invention, the radially inner apex portion has a much smaller cross-sectional area than was previously conventional, the cross-sectional area of the radially inner apex portion being smaller than in hitherto conventional apexes by at least a third, even tending towards at least 50% smaller. Although the radially inner apex portion is “small”, as a result of the rigid rubber material thereof (greater stress at 100% elongation), there remains a high level of bead stability (good bead durability) overall, and therefore the commercial vehicle tire is extremely suitable for retreading. In particular, the bead durability is greatly improved by comparison with currently conventional one-part apexes. The radially outer apex portion, which is thus designed to have a larger cross-sectional area than has been conventional up to now, consists of a rubber material, of which the rebound resilience at 70 °C is much greater than that of the rubber material of the radially inner apex portion. The rubber material of the radially outer apex portion is thus optimized in terms of the rolling resistance of the tire. In this case, the rolling resistance is greatly improved in particular by comparison with known commercial vehicle tires with the two-part apexes which have been conventional up to now (low rolling resistance). The commercial vehicle tire according to the invention is thus greatly improved in terms of the conflict of objectives between the rolling resistance and the bead stability.

According to one preferred embodiment, the surface area of the cross-sectional area of the radially inner apex portion is 70% to 140%, in particular 75% to 130%, preferably 80% to 120%, particularly preferably up to 100%, of the surface area of the cross-sectional area of the bead core. This is particularly advantageous in terms of the conflict of objectives to be resolved.

According to another preferred embodiment, the stress at 100% elongation of the rubber material of the radially inner apex portion is greater than the stress at 100% elongation of the rubber material of the radially outer apex portion by 3.00 MPa to 25.00 MPa, preferably by 4.00 MPa to 18.00 MPa, particularly preferably by 4.50 MPa to 16.00 MPa, most preferably by 6.00 MPa to 12.00 MPa. The indicated differences have in particular proven to be particularly advantageous for the bead durability of the tire.

In addition, it is advantageous for the bead durability when the stress at 100% elongation of the rubber material of the radially outer apex portion is 0.50 MPa to 9.00 MPa, in particular 0.75 MPa to 7.50 MPa, preferably 1.00 MPa to 6.00 MPa, and particularly preferably 2.50 MPa to 5.00 MPa.

Another preferred embodiment is characterized in that the rebound resilience at 70 °C of the rubber material of the radially outer apex portion is greater than the rebound resilience at 70 °C of the rubber material of the radially inner apex portion by 7.5 to 45.0 percentage points, preferably by 9.0 to 40.0 percentage points, and particularly preferably by 10.0 to 30.0 percentage points. This contributes to a further reduction in the rolling resistance of the tire.

Furthermore, it is advantageous for the rolling resistance of the tire when the rebound resilience at 70 °C of the rubber material of the radially inner apex portion is 25% to 65%, in particular 30% to 60%, and preferably at least 45%.

According to another preferred embodiment, the carcass inlay has a single-layer design, and ends in each bead region as a carcass turn-up having a height determined in the radial direction, the radially inner apex portion having a maximum height determined in the radial direction on the side thereof facing the tire inner side, which is in contact with the carcass inlay, of 60% to 100%, in particular of 70% to 90%, of the height of the carcass turn-up, the maximum height and the height relating to a line which, when viewed in the tire cross section, extends in the axial direction through a point in the bead region of the commercial vehicle tire which corresponds to the rim transition point. This embodiment is also additionally advantageous for the rolling resistance and the bead durability.

According to an alternative further preferred embodiment, the carcass inlay has a multi-layer design, each layer of the carcass inlay ending in each bead region as a carcass turn-up having a height determined in the radial direction, the radially inner apex portion having a maximum height determined in the radial direction on the side thereof facing the tire inner side, which is in contact with the carcass inlay, of 60% to 100%, in particular of 70% to 90%, of the height of the highest carcass turn-up, the maximum height and the height relating to a line which, when viewed in the tire cross section, extends in the axial direction through a point in the bead region of the commercial vehicle tire which corresponds to the rim transition point. This embodiment is likewise additionally advantageous for the rolling resistance and the bead durability.

In the two last-mentioned preferred embodiments, the height of the carcass turn-up is in particular 25.0 mm to 50.0 mm, preferably 30.0 mm to 45.0 mm.

Preferably, the cross-sectional area of the radially inner apex portion is triangular, the radially inner apex portion tapering off on the end thereof facing away from the bead core. This embodiment is additionally advantageous in terms of the conflict of objectives between the rolling resistance and the bead durability.

Furthermore, in the two last-mentioned embodiments, it is advantageous when the radially outer apex portion, when viewed in the tire cross section, extends in between the or each carcass turn-up and the radially inner apex portion.

Preferably, the commercial vehicle tire is provided for mounting on a 15°-drop-center rim standardized in accordance with E.T.R.T.O. standards with a width code of 5.25 to 18.00.

The use of the commercial vehicle tire according to the invention on a 15°-drop-center rim standardized in accordance with E.T.R.T.O. standards with a width code of 5.25 to 18.00 is thus particularly advantageous.

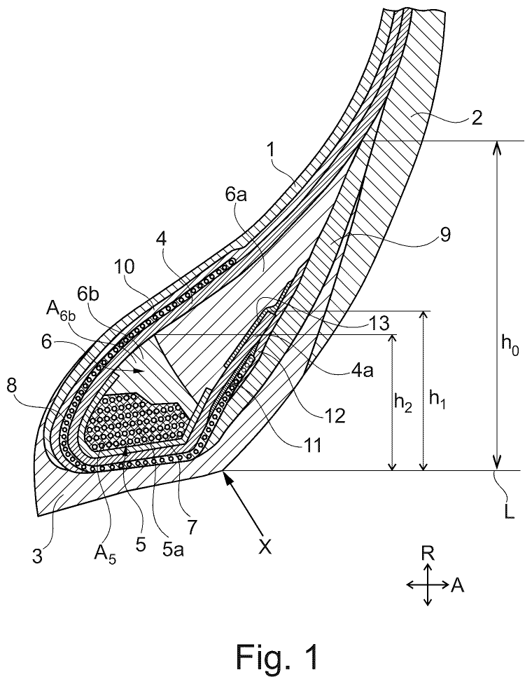

Further features, advantages and details of the invention are now explained on the basis of the single FIGURE, FIG. 1, which schematically shows a cross section through one of the bead regions of a commercial vehicle tire with an embodiment of the invention.

Commercial vehicle tires designed according to the invention are tires for multi-track commercial vehicles, preferably for medium-weight trucks (7.5 t<gross vehicle weight≤18.0 t), for heavy trucks (gross vehicle weight >18.0 t), or for buses, and in particular commercial vehicle tires of radial construction.

The heights indicated in the following are measured in the radial direction (indicated by the double arrow R) and each relate to a line L which, in the case of a commercial vehicle tire which is fitted on a suitable rim and is not pumped up, when viewed in the tire cross section, extends in the axial direction (indicated by the double arrow A) through a point X in the respective bead region of the commercial vehicle tire which corresponds to the rim transition point. The axial direction is understood to mean the direction extending parallel to the axis of rotation of the commercial vehicle tire. The radial direction corresponds to the direction extending perpendicularly to the axial direction in the tire cross section. In a known manner, the rim transition point is the point of intersection of the rim shoulder and the rim flange. The heights are determined by means of a tire circumferential portion which is applied to a rim and is cut out of a vulcanized pneumatic vehicle tire. Alternatively, the heights can be determined by means of computer tomography.

FIG. 1 shows a cross section through a bead region of a vulcanized commercial vehicle tire. The second bead region (not shown) is designed to match the bead region shown.

The commercial vehicle tire is provided in particular for mounting on a 15° drop-center rim, which is designed in accordance with the European Tyre and Rim Technical Organisation Standards Manual (“E.T.R.T.O Standards”), in the current version (as of 19.07.2022), section 15° Drop-Center Rims (width codes 5.25 to 18, 00) with nominal diameters of 17.5 inches, 19.5 inches, 20.5 inches, 22.5 inches or 24.5 inches.

In FIG. 1, the components of the commercial vehicle tire are shown as a portion of an airtight inner layer 1, a portion of a side wall 2, a flange profile 3, a portion of a single-layer carcass inlay 4, a bead core 5, a two-part apex 6 sitting on the bead core 5, a flipper strip 7, a steel cord bead reinforcement 8, a filler profile 9 and a filler profile 10. All of these components extend over the entire tire circumference, and are thus components which revolve in a circumferential direction in the form of a ring.

The side wall 2 overlaps the flange profile 3 on the outer side of the tire. The carcass inlay 4 consists of steel cords which are embedded in rubber and run without crossing and substantially parallel to one another, the carcass inlay 4 extending in a known manner between the two bead cores 5, being wrapped around each bead core 5 from the tire inner side facing the inner layer 1 coming toward the tire outer side and ending on the tire outer side next to the apex 6 as a carcass turn-up 4a at a height h₁ of 25.0 mm to 50.0 mm, preferably of 30.0 mm to 45.0 mm. The flipper strip 7 consists of a rubberized textile fabric, in particular of a rubberized nylon fabric, and is laid around the bead core 5 in such a way that it separates the carcass inlay 4 from the bead core 5. The steel cord bead reinforcement 8 consists of steel cords which are embedded in rubber and run without crossing and substantially parallel to one another, extends in contact with the side of the carcass inlay 4 facing away from the bead core 5 and ends on the tire inner side and tire outer side in each case in the region of the apex 6, the steel cord bead reinforcement ending before the end of the carcass turn-up 4a on the tire outer side. The filler profile 9 is located on the tire outer side of the bead core 5 and the apex 6, and extends—in each case in some portions—between the steel cord bead reinforcement 8 and the flange profile 3, between the carcass turn-up 4a and the flange profile 3, and between the apex 6 and the flange profile 3 or the side wall 2. The filler profile 10 extends between the two bead regions, is located in each bead region on the tire inner side of the bead core 5 and the apex 6, and extends in each bead region in some portions between the steel cord bead reinforcement 8 and the inner layer 1 and in some portions between the inner layer 1 and the carcass inlay 4.

The bead core 5 consists of a core wire 5a revolving in the circumferential direction having a high tensile strength and embedded in rubber material, which wire is in particular made of metal and preferably has a circular cross section. The bead core 5a is formed in a known manner by winding a single core wire 5a embedded in rubber material or by winding a plurality of core wires 5a embedded in rubber material. When viewed in the tire cross section, the bead core 5 has a cross-sectional area having a surface area A₅. In the case of a bead core 5 made of a single core wire 5a, the surface area A₅ of the cross-sectional area of the bead core 5 is calculated from the maximum number of windings multiplied by the surface area of the cross-sectional area of the core wire 5a. Depending on the point in the cross section, the number of windings can vary by one winding. The “maximum number of windings” is the number of windings at a point where the greatest number of windings can be found. In the case of a bead core 5 made of a plurality of core wires 5a, the surface area A₅ of the cross-sectional area of the bead core 5 is calculated from the number of core wires 5a multiplied by the surface area of the cross-sectional area of one core wire 5a. When determining the surface area A₅, the rubber material surrounding the core wire 5a or the core wires 5a is therefore still not taken into account.

The two-part apex 6 is composed of a radially outer apex portion 6a which is preferably not in contact with the bead core 5 and consists of a rubber material, and a radially inner apex portion 6b which is in contact with the bead core 5 and likewise consists of a rubber material. The rubber materials of the apex portions 6a, 6b differ in terms of the stresses thereof at 100% elongation and in terms of the rebound resilience thereof at 70 °C, as will be explained below.

In the exemplary embodiment shown, the radially inner apex portion 6b, when viewed in the tire cross section, has a substantially triangular cross-sectional area, tapers off on the end thereof facing away from the bead core 5 along a portion of the carcass inlay 4 extending along a tire inner side and reaches a maximum height h₂ (height at the highest point) which is 60% to 100%, in particular 70% to 90%, of the above-mentioned height h₁ of the carcass turn-up 4a. The cross-sectional area of the radially inner apex portion 6b has a surface area A_{6b} which is 60% to 160%, in particular 70% to 140%, preferably 75% to 130%, particularly preferably 80% to 120%, most preferably up to 100%, of the surface area A₅ of the cross-sectional area of the bead core 5.

When viewed in the tire cross section, the radially outer apex portion 6a extends in between the carcass turn-up 4a and the radially inner apex portion 6b, separates thus, together with the flipper strip 7, the radially inner apex portion 6b from the carcass turn-up 4a, and, in the radial direction, reaches a height h₀ which is greater than the above-mentioned height h₁ of the carcass turn-up 4a.

The above-mentioned stresses at 100% elongation were determined in accordance with DIN 53504 (Testing of rubber and elastomers—Determination of tensile strength at break, tensile stress at yield, elongation at break and stress values in a tensile test (2017-03 edition), test piece type S3).

The rebound resilience at 70 °C was determined in accordance with ISO 4662 (Elastomers or thermoplastic elastomers-Determination of rebound resilience of vulcanizates (2017-06 edition, Pendulum method according to Section 5)), in which the thickness of the test piece was 6.3 mm±0.5 mm, as mentioned in Annex A (Use of non-standard test pieces).

The rebound resilience at 70 °C serves as an indicator of the rolling resistance of the tire, with high rebound resilience at 70 °C meaning low rolling resistance.

The rubber material of the radially outer apex portion 6a has a stress at 100% elongation which is 0.50 MPa to 9.00 MPa, in particular 0.75 MPa to 7.50 MPa, preferably 1.00 MPa to 6.00 MPa, and particularly preferably 2.50 MPa to 5.00 MPa. The rubber material of the radially inner apex portion 6b has a stress at 100% elongation which is greater than the stress at 100% elongation of the rubber material of the radially outer apex portion 6a by 2.00 MPa to 30.00 MPa, in particular by 3.00 MPa to 25.00 MPa, preferably by 4.00 MPa to 18.00 MPa, particularly preferably by 4.50 MPa to 16.00 MPa, most preferably by 6.00 MPa to 12.00 MPa.

The rubber material of the radially outer apex portion 6a further has a rebound resilience at 70 °C which is greater than the rebound resilience at 70 °C of the rubber material of the radially inner apex portion 6b by 5.0 to 50.0 percentage points, in particular by 7.5 to 45.0 percentage points, preferably by 9.0 to 40.0 percentage points, and particularly preferably by 10.0 to 30.0 percentage points. The rubber material of the radially inner apex portion 6b has a rebound resilience at 70 °C which is 25% to 65%, in particular 30% to 60%, and preferably at least 45%.

In the exemplary embodiment shown, three reinforcing strips 11, 12, 13 consisting of rubber and revolving in the circumferential direction are installed on the apex 6 on the outer side of the tire. The reinforcing strip 11 extends between the carcass turn-up 4a and the steel cord bead reinforcement 8. The reinforcing strip 12 extends over the entire extent thereof in contact with the filler profile 9 and in each case in some portions in contact with the steel cord bead reinforcement 8, the carcass turn-up 4a and the radially outer apex portion 6a. The reinforcing strip 13 covers the free end of the carcass turn-up 4a and extends in each case in some portions in contact with the radially outer apex portion 6a and the reinforcing strip 12.

Table 1 shows examples of rubber compounds A and B. The reported amounts of the constituents of the rubber compounds A and B are provided in the conventional unit for rubber technology phr (parts per hundred parts rubber). The reported amounts are based in each case on 100 parts by mass of the base polymer. From the rubber compounds A and B, tires having correspondingly constructed apexes, as indicated in Table 2, were produced and compared, as explained below Table 1.

TABLE 1
Recipes

| | Rubber compound | Rubber compound |
|---|---|---|
| | A (RC A) | B (RC B) |
| Natural rubber | 100 | 100 |
| N 339 carbon black | 90 | 25 |
| BET 160 silica (silicic acid) | 0 | 15 |
| Oil (plasticizer) | 6 | 3 |
| Phenol resin | 5 | 0 |
| Aging inhibitor | 5 | 5 |
| Zinc oxide (activator) | 3 | 3 |
| Stearic acid (activator) | 2 | 2 |
| Accelerator | 3 | 1.5 |
| Sulfur | 2.5 | 2.5 |

Commercial vehicle tires provided for a steering axis, having the tire size 315/70 R 22.5, were produced, which differ solely in terms of the design of the apex. The apexes had a corresponding cross-sectional shape and thus cross-sectional areas having a corresponding size. The differences between the apexes can be seen in Table 2. Table 2 further contains results of tire tests, in which a rolling resistance test was carried out in accordance with ISO 28580 (Passenger car, truck and bus tyre rolling resistance measurement method—Single point test and correlation of measurement results, 2018-07 edition) and a specially developed bead durability test (drum test) was carried out. The test result for the bead durability of the reference tire Ref. 1 was limited to a value of 100. Values lower than 100 indicate a deterioration in the bead durability.

TABLE 2
Tire test results

| | Reference | Reference | Tire |
|---|---|---|---|
| | tire | tire | according to |
| | Ref. 1 | Ref. 2 | the invention |
| Construction of the apex | two-part | single-part | two-part |
| single-part apex | — | RC B | — |
| radially outer apex portion | RC B | — | RC B |
| radial inner apex portion | RC A | — | RC A |
| surface area cross-sectional | 240 | — | 104 |
| area | | | |
| radial inner apex portion | | | |
| [% surface area cross- | | | |
| sectional area bead core] | | | |
| Result of rolling resistance | 3.99 kg/t | 3.90 kg/t | 3.90 kg/t |
| test | | | |
| Result of bead durability test | 100% | 95% | 100% |

From Table 2, it can be seen that the commercial vehicle tire according to the invention has a much lower rolling resistance in comparison with the reference tire Ref. 1 and remains good in terms of bead durability. It can further be seen from Table 2 that, in comparison with the reference tire Ref. 2, the commercial vehicle tire according to the invention remains good in terms of rolling resistance and is much better in terms of bead durability.

Furthermore, corresponding tests have been carried out with a tire of the above-mentioned size provided for a drive axle and a tire of the above-mentioned size provided for a trailer axle. These tests also show corresponding improvements of tires according to the invention in terms of rolling resistance and bead durability.

The invention is not limited to the exemplary embodiment described.

Additional reinforcing plies containing reinforcing materials and additional reinforcing strips consisting of rubber can be installed in the bead region of the tire. The carcass inlay 4 can be designed with multiple layers, in particular two or three layers. In the case of a multi-layer carcass inlay, the carcass turn-ups of the layers of the carcass inlay can end at different heights to one another. When viewed in the tire cross section, the radially inner apex portion 6b can have a cross-sectional area which is different from the triangular cross-sectional area. The already mentioned maximum height h₂ of the radially inner apex portion 6b is 60% to 100%, in particular 70% to 90%, of the height of the highest carcass turn-up. The flipper strip 7 of the steel cord bead reinforcements 8 and the reinforcing strips 11, 12, 13 are optional. The cross-sectional area of the bead core is in particular hexagonal or circular. Alternatively, the cross-sectional area of the bead core has a shape which is derived from the shape of a hexagon or a circle. A derived shape of this type is for example a cross-sectional area in the form of a hexagon having a cut-out corner region which is approximately parallelogram shaped.

### LIST OF REFERENCE SIGNS

1 . . . Inner layer
2 . . . Side wall
3 . . . Flange profile
4 . . . Carcass inlay
4a . . . Carcass turn-up
5 . . . Bead core
5a . . . Core wire
6 . . . Apex
6a . . . Radially outer apex portion
6b . . . Radial inner apex portion
7 . . . Flipper strip
8 . . . Steel cord bead reinforcement
9 . . . Filler profile
10 . . . Filler profile
11 . . . Reinforcing ply
12 . . . Reinforcing ply
13 . . . Reinforcing ply
A . . . Double arrow (axial direction)
A₅, A_{6b} . . . . Surface area
h₀, h₁ . . . Height
h₂ . . . Maximum height
L . . . Line
R . . . Double arrow (radial direction)
X . . . Point

1. A commercial vehicle tire comprising:
bead regions each having a bead core, a two-part apex sitting radially outward on the bead core, and a flange profile, and further comprising a single-layer or multi-layer carcass inlay wrapped around the bead cores;
each apex being composed of a radially outer apex portion and a radially inner apex portion which is in contact with the bead core, the radially outer apex portion and the radially inner apex portion each comprising of a rubber material, and the rubber material of the radially outer apex portion being different from the rubber material of the radially inner apex portion,
wherein
the radially inner apex portion has a cross-sectional area having a surface area of 60% to 160% of the surface area of the cross-sectional area of the bead core,
the rubber material of the radially inner apex portion has a stress at 100% elongation—determined in accordance with DIN 53504 with the test piece type S3—which is 2.00 MPa to 30.00 MPa greater than the stress at 100% elongation of the rubber material of the radially outer apex portion and;
the rubber material of the radially outer apex portion has a rebound resilience at 70 °C—determined in accordance with ISO 4662, with a test piece having a thickness of 6.3 mm±0.5 mm according to Annex A of ISO 4662—greater than the rebound resilience at 70 °C of the rubber material of the radially inner apex portion by 5.0 to 50.0 percentage points.

2. The commercial vehicle tire as claimed in claim 1, wherein the surface area of the cross-sectional area of the radially inner apex portion is 70% to 140%.

3. The commercial vehicle tire as claimed in claim 1, in that the stress at 100% elongation of the rubber material of the radially inner apex portion is greater than the stress at 100% elongation of the rubber material of the radially outer apex portion by 3.00 MPa to 25.00 MPa.

4. The commercial vehicle tire as claimed in claim 1, in that the stress at 100% elongation of the rubber material of the radially outer apex portion is 0.50 MPa to 9.00 MPa.

5. The commercial vehicle tire as claimed in claim 1, in that the rebound resilience at 70 °C of the rubber material of the radially outer apex portion is greater than the rebound resilience at 70 °C of the rubber material of the radially inner apex portion by 7.5 to 45.0 percentage points.

6. The commercial vehicle tire as claimed in claim 1, in that the rebound resilience at 70 °C of the rubber material of the radially inner apex portion is 25% to 65%.

7. The commercial vehicle tire as claimed in claim 1, in that the carcass inlay has a single-layer design, and ends in each bead region as a carcass turn-up having a height determined in the radial direction, the radially inner apex portion having a maximum height determined in the radial direction on the side thereof facing the tire inner side, which is in contact with the carcass inlay, of 60% to 100%, of the height (h1) of the carcass turn-up, the maximum height and the height relating to a line (L) which, when viewed in the tire cross section, extends in the axial direction through a point in the bead region of the commercial vehicle tire which corresponds to the rim transition point.

8. The commercial vehicle tire as claimed in claim 1, in that the carcass inlay has a multi-layer design, each layer of the carcass inlay ending in each bead region as a carcass turn-up having a height determined in the radial direction (double arrow R), the radially inner apex portion having a maximum height determined in the radial direction (double arrow R) on the side thereof facing the tire inner side, which is in contact with the carcass inlay, of 60% to 100% of the height (h1) of the highest carcass turn-up the maximum height (h2) and the height (h1) relating to a line (L) which, when viewed in the tire cross section, extends in the axial direction (double arrow A) through a point in the bead region of the commercial vehicle tire which corresponds to the rim transition point.

9. The commercial vehicle tire as claimed in claim 8, in that the height (h1) of the carcass turn-up (4a) is 25.0 mm to 50.0 mm, preferably 30.0 mm to 45.0 mm.

10. The commercial vehicle tire as claimed in claim 1, in that the cross-sectional area of the radially inner apex portion is triangular, the radially inner apex portion tapering off on the end thereof facing away from the bead core.

11. The commercial vehicle tire as claimed in claim 10, in that the radially outer apex portion, when viewed in the tire cross section, extends in between the or each carcass turn-up and the radially inner apex portion.

12. The commercial vehicle tire as claimed in claim 11, in that it is provided to be mounted on a 15°-drop-center rim standardized in accordance with E.T.R.T.O. standards with a width code of 5.25 to 18.00.

13. The tire of claim 1, wherein the tire complies with a 15°-drop-center rim standardized in accordance with E.T.R.T.O. standards with a width code of 5.25 to 18.00.

14. A commercial vehicle tire comprising:
bead regions each having a bead core, a two-part apex sitting radially outward on the bead core, and a flange profile, and further comprising a single-layer or multi-layer carcass inlay wrapped around the bead cores;
each apex being composed of a radially outer apex portion and a radially inner apex portion which is in contact with the bead core, the radially outer apex portion and the radially inner apex portion each comprising of a rubber material, and the rubber material of the radially outer apex portion being different from the rubber material of the radially inner apex portion,
wherein:
the radially inner apex portion has a cross-sectional area having a surface area of 60% to 160% of the surface area of the cross-sectional area of the bead core,
the rubber material of the radially inner apex portion has a stress at 100% elongation—determined in accordance with DIN 53504 with the test piece type S3—which is 2.00 MPa to 30.00 MPa greater than the stress at 100% elongation of the rubber material of the radially outer apex portion and;
the rubber material of the radially outer apex portion has a rebound resilience at 70 °C—determined in accordance with ISO 4662, with a test piece having a thickness of 6.3 mm±0.5 mm according to Annex A of ISO 4662—greater than the rebound resilience at 70 °C of the rubber material of the radially inner apex portion by 5.0 to 50.0 percentage points;
wherein the surface area of the cross-sectional area of the radially inner apex portion is 70% to 140%;
wherein the stress at 100% elongation of the rubber material of the radially inner apex portion is greater than the stress at 100% elongation of the rubber material of the radially outer apex portion by 3.00 MPa to 25.00 MPa; and
wherein the rebound resilience at 70 °C of the rubber material of the radially outer apex portion is greater than the rebound resilience at 70 °C of the rubber material of the radially inner apex portion by 7.5 to 45.0 percentage points.
